(19) United States
(12) Patent Application Publication
(10) Pub. No.: US 2005/0107602 A1
(43) Pub. Date: May 19, 2005

(54) Method for producing cellulose carbamate

(76) Inventor: Fritz Loth, Teltow (DE)

Correspondence Address: Law Offices of Karl Hormann, PO Box 381516, Cambridge, MA, 02238-1516, US

(21) Appl. No.: 10/499,527

(22) PCT Filed: Nov. 20, 2002
(86) PCT No.: PCT/DE02/04266

(30) Foreign Application Priority Data
Dec. 20, 2001 (DE) 101 62 791.2

(51) Int. Cl. C08B 5/00

(52) U.S. Cl. 536/32; 204/157.68

(57) ABSTRACT

A method of producing cellulose carbamate by reacting cellulose with urea heating the reaction mixture by electromagnetic radiation of a frequency range between 100 MHz and 100 GHz for 2 minutes to 3 hours to a temperature in the range from 100 to 250° C.

### BACKGROUND OF THE INVENTION

1. Field of the Invention

The invention relates to a method of producing cellulose carbamate by reacting cellulose with urea.

2. The Prior Art

Most prior art methods of producing cellulose carbamate are based upon suitably activating cellulose followed by heating it above 130° C. in the presence of urea. At such temperatures, urea is melting (melting point of urea 132.7° C.) and disintegrates into isocyanic acid and ammonia. The resultant isocyanic acid reacts with the free hydroxyl groups of the cellulose and forms the corresponding unsubstituted cellulose carbamates (Comprehensive Cellulose Chemistry, Vol. 2, Wiley-VCH, Weinheim (Germany), 1998, pp. 161 ff.)

U.S. Pat. Nos. 2,129,708 and 2,134,825 disclose the production of cellulose carbamate by heat reaction of cellulose with urea. They describe that by steeping cellulose in an alkaline solution containing urea, squeezing out excess liquid, drying and heating the urea containing cellulose to temperatures between 120 and 300° C., as well as washing out of byproducts, cellulose carbamate solvable in alkali may be obtained. Since cellulose is a poor heat conductor, dry heating in a conventional oven suffers from the significant drawback of the transfer of heat from the wall of the reactor leading to a non-uniform temperature distribution in the reaction mixture. This leads to long reaction times, high energy application and to irregularities in the reaction product by localized excess heating at the surface of the reaction mixture, which adversely affect the quality of the cellulose carbamate. Complete dissolution of the cellulose carbamate is possible only in the presence of degrees of substitution of 0.2 and more, and if the substituents are uniformly distributed and if cross-linkage is as low as possible.

DE 198 35 688 and 196 35 707 describe the heating of activated cellulose in excess molten urea which avoids the problem of localized overheating. However, the great quantities of urea (a quantity of urea 3 to 50 times relative to the weight of the cellulose), renders the necessary removal and recovery of excess urea difficult.

DE 42 42 437 and DE 44 17 140 describe the use of organic solvents as a suspension medium which, with water, form azeotropic mixtures, as well as the removal of adhering water. While this results in improved heat transmission, problems arise in respect of handling large quantities of these combustible and insalubrious solvents, for instance of the 23-fold quantity of toluene relative to the weight of the cellulose, or of the 22-fold quantity of xylene, their removal from the reacting mixture and their recovery poses problems.

### OBJECT OF THE INVENTION

It is an object of the invention to overcome the drawbacks of the prior art and to provide a method of producing cellulose carbamate which is technically simple and which is advantageous from a point of view of economics. Other objects will, in part, be obvious and will, in part, appear hereinafter.

### SUMMARY OF THE INVENTION

In a preferred embodiment, the object is accomplished by reacting cellulose with molten or dissolved urea and by heating the reaction mixture to a temperature range between 100 and 250° C. for from 2 minutes to 3 hours by electromagnetic radiation in a frequency range of from 100 MHz to 100 GHz.

### DETAILED DESCRIPTION OF THE INVENTION

The subject matter of the invention is a method of producing cellulose carbamate from cellulose and urea in which cellulose is heated in the presence of dissolved or molten urea by electromagnetic radiation of a frequency from 100 MHz to 100 GHz (microwave range) to temperatures between 100 and 250° C. for from 2 minutes to 3 hours.

This method accomplishes the object of the invention by a uniform temperature distribution in the reaction mixture during thermal treatment of the cellulose-urea mixture.

Compared to heating in conventional ovens or reactors in the presence of large quantities of suspension media as heat transfer agents, such as organic solvents or excess urea, or compared to dry heating, the method in accordance with the invention offers the advantage of the reaction temperature being reached in a short time. Moreover, the energy distribution in the reaction mixture is almost homogeneous because of the uniform distribution in the cellulose of the urea which is activated by the microwaves penetrating to a depth of several centimeters. As a result, even in seemingly dry and almost liquid-free reaction mixtures, the problem of poor heat transmission which leads to a non-uniform temperature distribution and, therefore, to a non-uniform product of poor quality, has been solved in a surprising manner. Noticeably shorter reaction periods suffice for attaining the desired uniform degree of substitution of from 0.2 to 0.4. Compared to those methods which avoid the heat transfer problem by adding large quantities of suspension media, energy efficiency in the method in accordance with the invention is markedly more favorable, since it requires no heating of suspension media in addition to the reactants.

The cellulose used may be wood pulp, cotton linters or regenerated cellulose in various conditions and commercial grades. The degrees of polymerization of the cellulose may vary widely. However, chemical conversion pulps or linters of degrees of polymerization between 300 and 800 are preferred.

For intimately mixing (impregnation) with urea, the cellulose is treated with a solvent containing 40 to 60 percent by weight of urea. Excess urea solution is removed by suction, squeezing or spinning. Residual water which interferes with the cellulose carbamate reaction, is removed by drying the reaction mixture in a conventional oven or in a microwave oven.

As regards an effective absorption of the microwave radiation and a problem-free and uniform reaction, it is decisive to provide the urea in a dissolved or molten state. For that reason it has been found to be advantageous to add a small amount of an inert high-boiling solvent at any stage of the process prior to the microwave irradiation. The solvent may either be added already to the dipping solution for impregnating the cellulose, or after the impregnation, or it may be added to the squeezed-out or sucked-off reaction mixture before or after drying for the removal of water.

Depending upon the reaction temperature, 2 minutes may suffice; or up to 3 hours may be required until the desired degree of substitution of from 0.2 to 0.4 has been reached. The irradiation periods commonly are 5 to 30 minutes. The useful temperature range is limited upwardly to about 300° C. by the decomposing cellulose and downwardly the quantity of isocyanic acid required for this reaction and derived from the urea beginning at about 100° C.

The reaction results in usually beige-colored or slightly brown products which after washing, e.g. in hot water, are almost white or light-beige, and which directly or after drying dissolve clearly in a cold 6 to 10% sodium hydroxide solution. From these solutions fibers, foils, beads, sponges or other molded bodies may be produced by correspondingly shaping or precipitating or regenerating the cellulose.

In a preferred embodiment of the method in accordance with the invention, the reaction is carried out at 130 to 220° C. In this temperature range, the rate of reaction relative to the formation of undesirable byproducts and decomposition products is favorable.

In a further preferred embodiment 1-methyl-2-pyrrolidone and/or polyethylene glycol are used as solvents for the urea. These solvents subject the urea into a state activatable by microwaves and ensure a uniform distribution of heat energy in the reaction mixture.

In a further preferred embodiment of the method in accordance with the invention, the solvents are used in a quantity of 10 to 100% by weight based upon the cellulose. These quantities are sufficiently small to make the reaction product appear to be dry in view of the fact that the solvent is absorbed by the voluminous cellulose. This efficient use of solvents is advantageous in economical as well as ecological terms.

Instead of organic solvents, it is also possible to use excess molten urea, i.e. urea which is not required for the reaction as such, in order to improve the absorption of microwave irradiation.

In a further preferred embodiment of the method in accordance with the invention, microwave irradiation of a frequency of 915 MHz or 2.45 GHz is used. It will, however, be understood that the invention is not limited to these frequencies. These frequencies are in use in industrial and medical applications so that a plurality of magnetrons for generating the desired microwave irradiation are commercially available.

In a further preferred embodiment of the method in accordance with the 0.5 to 5 mol, preferably 1.0 to 3.0 mol of urea are used per mol of anhydroglucose unit (AGU). The quantity of urea leads to a degree of substitution from 0.2 to 0.4.

Chemically activated cellulose is used in a preferred embodiment of the invention for producing cellulose carbamate which clearly and completely dissolvable in sodium hydroxide solution. Activation is carried out by pre-treating the cellulose with a concentrated aqueous lye and washing out of excess alkali, or by a pretreatment in diluted aqueous lye or aqueous or liquid ammonia. The crystalline areas of the cellulose are expanded by lye or ammonia. In this manner, it is possible to achieve an even more homogeneous distribution of urea in the cellulose. Activation and impregnation may take place sequentially in two separate method steps by mixing the activated cellulose with dissolved urea or in one step by adding urea to the activating solution.

In a preferred embodiment of the invention, the reaction is carried out in the presence of a base, preferably 0.25 to 1 mol equivalent alkali hydroxide relative to 1 mol AGU. In the present of a base, the degradation of urea to isocyanic acid and ammonia is accelerated. It is thus possible to carry out the conversion to cellulose carbamate under milder conditions in order, at lower energy costs, to minimize the formation of undesirable byproducts and decomposition products.

In a variant of the method in accordance with the invention, the mixture of cellulose, molten or dissolved urea and, optionally, a base is continually transported through a microwave oven or several microwave modules whilst being irradiated at the same time. In this continuous method operation, the interruptions for loading and unloading the reactor are eliminated. This results in lower production costs since the running times of the machines or system may be increased.

A further advantage is derived from a variant of the method in accordance with the invention in which glucose is used in an unchopped condition, e.g. as plates or as an endless web. Since the uniform heat transfer does not take place by way of suspension media, but is assured by microwave activation instead, the method step of cutting up cellulose supplied in the form of plates or as an endless web can be avoided.

In an advantageous embodiment of the method in accordance with the invention, the ammonia released during the reaction is removed from the reaction chamber. This is done by vacuum pressure suction or exhaustion by means of a stream of air or inert gas. The reaction of the cellulose carbamate is improved by removal of the ammonia reaction product from the reaction equilibrium.

The invention will be explained in greater detail with reference to the following examples without, however, being thus limited.

### DESCRIPTION OF SPECIFIC EXAMPLES

### Example 1

In a kneader, a solution of 50 ml of 8% sodium hydroxide solution and 20 g (0.3 mol) of urea are poured over 17.8 g (0.1 mol) of ground spruce sulfite pulp (water contents 9%, DP_{Cuoxam} 650). After 30 minutes the homogeneous mass is removed and is dried at 60° C. in an ambient air drying cabinet.

10 g each of the dry reaction mixture are transferred to a glass round bottom flask and mixed with
a) 50 ml of 1-methyl-2-pyrrolidone;
b) 50 ml of polyethylene glycol (PEG 400);
c) 50 g of urea.
   In a microwave oven the reaction mixtures are heated to 180° C. within 2 minutes, are stirred at this temperature for 10 minutes and are thereafter cooled to 50° C. In the case of c) the excess urea is initially melted in the presence of the actual reaction mixture and only afterwards is the complete sample heated in the microwave oven whilst being stirred. The products are imbibed with water and washed with hot water five time on a frit. After sucking off the liquid, the products are dried at 60° C. in an ambient air drying cabinet. In all cases, almost white glucose carbamates are obtained which clearly and completely dissolve in 10% sodium hydroxide solution.

### Example 2

36.5 g (0.2 mol) of ground spruce sulfite pulp (water content 9%, DP_{Cuoxam} 650) are suspended in 400 ml of a 4% sodium hydroxide solution which contains 120 g of urea and which is spun off in a centrifuge after one hour. The cellulose absorbs 75 g (22.5 g=0.375 mol urea) of liquid. From the cellulose impregnated with alkaline urea solution, 50 g each are mixed in a kneader with
a) 5 ml of 1-methyl-2-pyrrolidone;
b) 5 ml of polyethylene glycol (PEG 200).
   And thereafter dried at 80° C. in an ambient air drying cabinet. At a layer thickness of about 1 cm, the dry samples are heated to 140° C. in a microwave oven for two hours each and then washed with hot water and thereafter with ethyl alcohol. The result is slightly yellow cellulose carbamates which are clearly and completely soluble in 10% sodium hydroxide solution.

### Example 3

Analogous to example 2, pulp is impregnated with an alkaline urea solution and then spun. Thereafter, 50 g of the undried reaction mixture is transferred on a glass plate as a layer of about 2 cm thickness into the microwave oven, is heated to 100° C. within one minute and thereafter is heated to 140° C. at a heating rate of 2′/m. The sample is cooled after a reaction time of 60 minutes, is washed with hot water and dried. The result is a slightly yellow discolored cellulose carbamate which completely dissolves in 10% sodium hydroxide solution.

### Example 4

8.8 g of an air dry pulp plate (10 cm×10 cm) are dipped for 5 minutes into a previously prepared solution of 96 ml of water, 4 g sodium hydroxide, 20 ml 1-methyl-2-pyrrolidone and 35 g of urea. The excess solution is then squeezed off with the cellulose absorbing 18.0 g of liquid (about 4.2 g of urea and 2.4 g of 1-methyl-2-pyrrolidone). The plate is first dried at 60° C. in an ambient air drying cabinet and is thereafter heated for 30 minutes to 150° C. in a microwave oven. Following that the plate is subjected to water in a mixer, washed with water and ethyl alcohol and dried. The result is a product which is colored slightly yellow and which complete dissolves in sodium hydroxide solution at −5° C.

### Example 5

100 g of ground spruce sulfite pulp are soaked in 500 g of 20% sodium hydroxide solution. After 15 minutes, excess sodium hydroxide solution is squeezed off, the pressed cake is chopped up, suspended in 3 l of water and excess liquid is removed. 100 g of this filtered cake which contains 25% cellulose and 2.5% sodium hydroxide (0.4 mol sodium hydroxide/1 mol AGU) is homogeneously mixed in a mixer with 10.2 g of urea (1.1 mol/1 mol AGU) and 10 ml polyethylene glycol (PEG 400) and is thereafter dried in vacuum at 80° C. The dried sample is placed as a layer 2 cm thick on a Teflon® plate and heated in a microwave oven to 220° C. while being flushed with nitrogen. The sample is then first washed with water and ethyl alcohol and thereafter dried. The result is cellulose carbamate of slightly yellow color which at −5° C. clearly and completely dissolves in a 10% sodium hydroxide solution.

1-17. (canceled)

18. A method of producing cellulose carbamate, comprising the steps of:
providing a reaction mixture of cellulose and at least one of molten and dissolved urea; and
inducing reaction of the mixture by heating with electromagnetic radiation of a frequency from 100 MHz and 100 GHz at a temperature between 100 and 250° C. for from 2 minutes to 3 hours.

19. The method of claim 18, wherein the reaction is carried out at 130 to 220° C.

20. The method of claim 18, wherein the urea is dissolved in a solvent from the group consisting of 1-methyl-2-pyrrolidone and polyethylene glycol.

21. The method of claim 20, wherein the quantity of solvent is 10 to 100% by weight relative to cellulose.

22. The method of claim 18, wherein the reaction is carried out in the presence of excess molten urea.

23. The method of claim 18, wherein frequency of the electromagnetic radiation is one of 915 MHz and 2.45 Ghz.

24. The method of claim 18, wherein 0.5 to 5 mol equivalents of urea are used per mol of anhydroglucose unit.

25. The method of claim 24, wherein 1 to 3 mol equivalents of urea are used per mol of anhydroglucose unit.

26. The method of claim 18, wherein the cellulose it chemically activated.

27. The method of claim 18, further comprising the step of adding a base to the reaction mixture.

28. The method of claim 27, wherein the base comprises 0.2 to 1 mol equivalent of alkali hydroxide per mol of anhydroglucose.

29. The method of claim 18, wherein the reaction mixture is continuously transported through one of a microwave oven and a plurality of microwave modules.

30. The method of claim 27, wherein the reaction mixture is continuously transported through one of a microwave oven and a plurality of microwave modules.

31. The method of claim 18, wherein the cellulose is unchopped (unbroken).

32. The method of claim 31, wherein the cellulose is in plate form.

33. The method of claim 31, wherein the cellulose is an endless web.

34. The method of claim 18, further comprising the step of removing freed ammonia.

35. The method of claim 34, wherein the ammonia is removed by vacuum pressure.

36. The method of claim 34, wherein the ammonia is removed by a stream of air.

37. The method of claim 34, wherein the ammonia is removed by a stream of inert gas.
